(19) United States
(12) Patent Application Publication
(10) Pub. No.: US 2007/0068985 A1
(43) Pub. Date: Mar. 29, 2007

(54) Bicycle stem mounted container

(76) Inventor: Toshikazu Nakahara, Kobe-shi (JP)

Correspondence Address: ROBERT J JACOBSON PA, 650 BRIMHALL STREET SOUTH, ST PAUL, MN, 551161511, US

(21) Appl. No.: 11/236,200

(22) Filed: Sep. 27, 2005

(51) Int. Cl. B62J 7/06; B62J 11/00; B62J 7/00

(52) U.S. Cl. 224/420; 224/463

(57) ABSTRACT

A bicycle stem and handlebar engaging container that is engaged to each of the stem and handlebar and that rides on the stem of the bicycle. A stem of a bicycle is a structural part of the bicycle that is disposed between the handlebar and the fork. A person turns the handlebars, which thus turns the stem, which thus turns the upper portion of the fork, which thus turns the lower portion of the fork, which thus turns the front wheel of the bicycle. A floor of the container rides on the stem. A first pair of quick connect and release straps engages the stem and a second and third pair of quick connect and release straps engage the handlebar. The second pair of quick connect and release straps includes a side strap and an end strap that engage each other. The third pair of quick connect and release straps includes a side strap and an end strap that engage each other.

### FIELD OF THE INVENTION

The present invention generally relates to a bicycle. engaging container, particularly to a bicycle stem mounted container, and specifically to a bicycle stem mounted container where a floor of the container rides on the bicycle stem.

### BACKGROUND OF THE INVENTION

A bicycle, in one sense, has a finite number of parts. Specifically, perhaps, a bicycle has only four parts: the frame, two wheels, and a means for transmitting power to at least one of the wheels.

A bicycle, in another sense, has an infinite number of parts limited only by the imagination and creativity of the cyclist. For example, the head tube is conventionally a part that receives the fork of a bicycle. However, to other cyclists, the head tube is also a wind break, behind which may be snuggled a box containing energy bars for the cycling portion of a triathlon.

### SUMMARY OF THE INVENTION

A feature of the present invention is the selection of a stem of a bicycle to engage the floor of a container.

Another feature of the present invention is the selection of a stem of a bicycle to engage the floor of a container and the further selection of a portion of the handlebar to further engage the container.

Another feature of the present invention is the provision, in a bicycle engaging container having a side panel, an end panel, and a floor, of a strap extending from the side panel that engages a strap extending from the end panel.

Another feature of the present invention is the provision, in a bicycle engaging container having a side panel, an end panel, a floor, and a corner formed by the side and end panel, of a pair of straps extending from the corner and engaging each other.

Another feature of the present invention is the provision, in a bicycle engaging container, of a container riding on a stem of the bicycle and of the container being engaged to the bicycle via a first pair of quick connect and release straps engaged to the stem of the bicycle, a second pair of quick connect and release straps engaged to a handlebar of the bicycle, and a third pair of quick connect and release straps engaged to the handlebar of the bicycle.

An advantage of the present invention is accessibility. Since the floor of the container rides on the stem, the opening or lid of the container is immediately available to and in close proximity to the hands of the rider, without the opening of the container being blocked by a portion of the bicycle.

Another advantage of the present invention is stability. The first pair of quick connect and release straps engages the container about a first axis (the axis of the stem) so as to minimize movement of the container relative to a second axis and so as to minimize transverse movement or side-to-side movement of the container. A second and third pair of quick connect and release straps engage the container about a second axis (the axis of a portion of the handlebar) that is perpendicular to the first axis so as to minimize spin of the container about the first axis and so as to minimize axial movement of the container along the stem. Stability is further enhanced by selecting aerobars to be mounted on the handlebars, where one of the aerobars confronts one of the side panels of the container and where the other of the aerobars confronts the other of the side panels. In short, the three pairs of quick connect and release straps provide for stability of a container at a T or at a T-connection, where each of the pair of connectors or straps engages one of the three arms of the T or T-connection.

Another advantage of the present invention is minimal wind resistance. The container is relatively thin, and the container is positioned such that the end panels point frontwardly and rearwardly. The thickness of the container (i.e., distance between the end panels) is preferably about the size of a head tube of a bicycle on which the container is mounted.

Another advantage of the present invention is relative size such that the container fits harmoniously into the frame of a bicycle. In other words, the length of the container (distance between the end panels) is about the length of the stem. The thickness of the container (distance between the side panels) is about the thickness of the stem of the bicycle. The height of the container (the distance between the floor and the lid) is relatively small so as to minimize interference with any portion of the rider such as the head of the rider or the elbows, forearms or hands of the rider.

Another advantage of the present invention is cost. The present container is easy and inexpensive to manufacture.

Another advantage of the present invention is relative weight. The present bicycle stem mounted container is relatively light (low in mass) so as to add minimal weight to the bicycle.

### BRIEF DESCRIPTION OF THE DRAWINGS

FIG. 1A is a side view of a bicycle having the bicycle stem mounted container engaged thereon.

FIG. 1B is a perspective detail view of a front portion of the bicycle of FIG. 1A having the bicycle stem mounted container engaged on the stem of a bicycle and fixed between a pair of aerobars.

FIG. 2A is a perspective stand alone view of the bicycle stem mounted container of FIG. 1A showing the quick connect and release straps unengaged and further showing the lid in an open position.

FIG. 2B is a side view of the bicycle stem mounted container of FIG. 1A showing the quick connect and release straps engaged about the stem of the bicycle and further engaged about the handlebar of the bicycle and further showing the lid in a closed position.

### DESCRIPTION

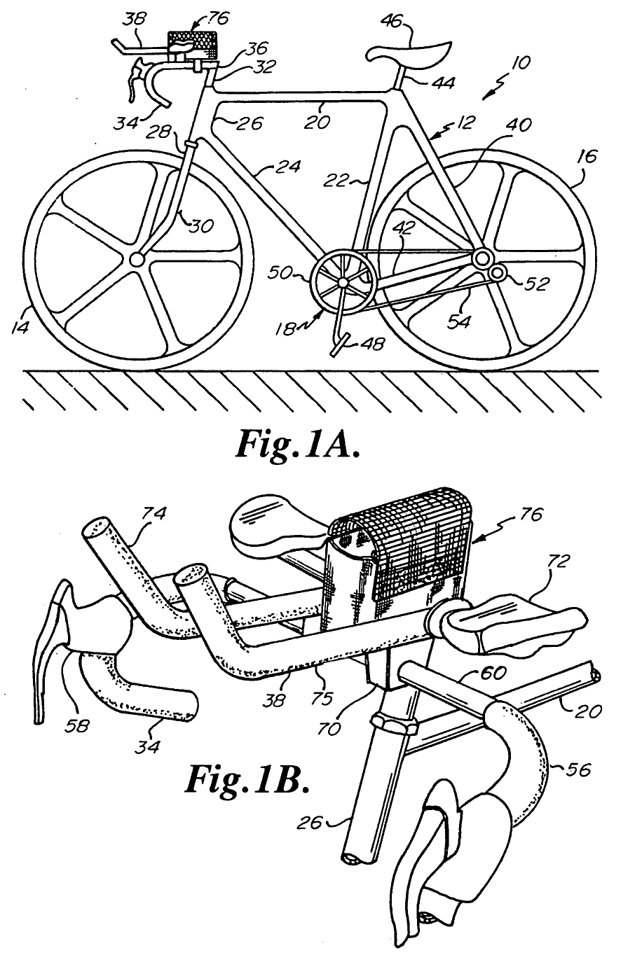

As shown in FIG. 1A, a bicycle 10 includes a frame 12, a front wheel 14, a rear wheel 16, and a power transmitting means 18. The frame 12 includes a top tube 20, a seat tube 22, a down tube 24, a head tube 26, a front fork 28 having a forked lower portion 30 and a post like upper portion 32, a set of handlebars 34, a stem 36 running between the handlebars 34 and post like upper portion 32 of the fork 28, a set of aerobars 38 mounted on the handlebars 34, an upper rear fork 40, a lower rear fork 42, a seat post 44, and a seat 46. The power transmitting means 18 includes a foot pedal 48, a front gear 50, rear gears 52, and a chain 54 between the front and rear gears 50 and 52.

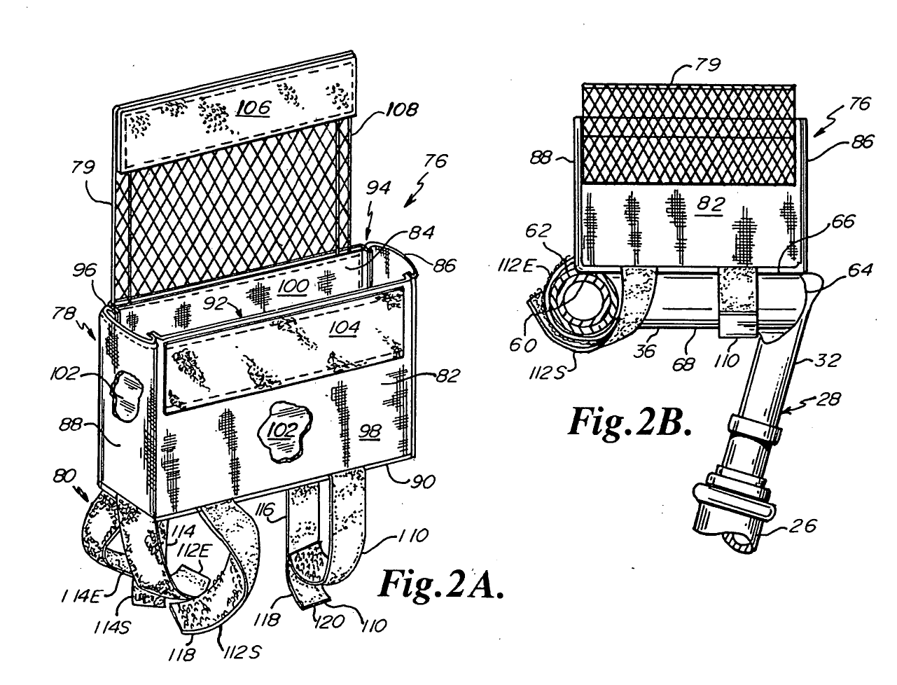

As shown in FIG. 1B, the set of handlebars 34 includes a pair of hand grips 56 and a pair of hand brakes 58. The set of handlebars 34 includes a single relatively straight handlebar section 60, where such relatively straight handlebar section 60 is shown in FIG. 1B and is further shown in FIG. 2B. The relatively straight handlebar section 60 is pivotally and slideably engaged to a distal end 62 of stem 36 as shown in FIG. 2B. The relatively straight handlebar section 60 can be tubular, as shown in FIG. 2B. The distal end 62 of stem 36 includes a cylindrical shaped through opening to pivotally and slideably accept and engage the relatively straight handlebar section 60. The distal end 62 of stem 36 can be shaped in the form of a clamp or pincher or pinching mechanism such that, upon turning a pin, a portion of the distal end 62 bites down on a portion of the handlebar section 60 to rigidly fix the handlebars 34 at the desired position. As shown in FIG. 2B, a proximal end 64 of the stem 36 is welded to the post like upper portion 32 of the fork 28. However, if desired, proximal end 64 of stem 36 can also be a clamp or pincher and include a cylindrical shaped through opening to accept and engage the post like upper portion 32 of the fork 38. Between the distal end 62 and the proximal end 64, stem 36 is relatively straight and is preferably tubular. Stem 36 includes an upper surface 66 and an opposing lower surface 68.

Stem 36 can take many shapes, structures and forms. As to stem 36, the following U.S. Patents are hereby incorporated by reference herein in their entireties: 1) the Thomson et al. U.S. Pat. No. 6,912,928 B1 issued Jul. 5, 2005 and entitled Bicycle Stem Including Enhanced Clamp and Associated Methods; 2) the Marui U.S. Pat. No. 6,416,071 B2 issued Jul. 9, 2002 and entitled Supporting Structure For A Fork Stem In A Bicycle And A Process Of Manufacturing A Supporting Portion For A Fork Stem In A Bicycle; 3) the Liao U.S. Pat. No. 6,244,131 issued Jun. 12, 2001 and entitled Stem For A Bicycle; 4) the Marui U.S. Pat. No. 5,687,616 issued Nov. 18, 1997 and entitled Handle Stem Fixing Device In A Bicycle; 5) the Marui U.S. Pat. No. 5,553,511 issued Sep. 10, 1996 and entitled Handle Stem Fixing Device In A Bicycle; 6) the Shimano U.S. Pat. No. 4,435,983 issued Mar. 13, 1984 and entitled Handle Stem For A Bicycle; and 7) the Katayama U.S. Pat. No. 4,274,301 issued Jun. 23, 1981 and entitled Handle Stem Fixing Device For A Bicycle And The Like.

Each of the aerobars or aero handlebars 38 includes a handlebar connector 70 that rigidly and adjustably fixes the aerobar 38 to the relatively straight handlebar section 60. Each of the aerobars 38 includes an arm or forearm or elbow rest 72 on a proximal end portion of the aerobar 38. At a distal end, each of the aerobars 38 includes a hand grip 74 that is an upwardly and forwardly turned portion of the aerobar 38. Between the proximal and distal ends, aerobar 38 includes a relatively straight section 75. Aerobar 38, including aerobar section 75, is preferably tubular. As to a set of aerobars 38, the following U.S. Patents are hereby incorporated by reference herein in their entireties: 1) the Klieber U.S. Pat. No. 5,154,094 issued Oct. 13, 1992 and entitled Aero-Type Handlebar with Forearm Supports; and 2) the Nakahara U.S. Pat. No. 5,803,328 issued Sep. 8, 1998 and entitled Bicycle Aerobar Bag.

The present bicycle stem mounted container is indicated by reference numeral 76 and is shown in FIGS. 1A, 1B, 2A, and 2B. Container 76 rests on or rides on the stem 36, and may further ride on a portion of handlebar section 60, and may further ride on a portion of the post like upper portion 32 of fork 28.

As shown in FIG. 2A, container 76 generally includes a body 78, lid 79, and connectors 80 for engaging the container 76 to one or more of the stem 36 and handlebar section 60. If desired, connectors 76 may further or alternatively engage one or more of the post like upper portion 32 of the fork 28 and some portion of the aerobars 38, such as connector 70 or aerobar relatively straight section 75.

Body 78 includes a front side panel 82, a rear side panel 84, a proximal end panel 86, a distal end panel 88, and a floor 90. Body 78 is parallelepiped. The side panels 82 and 84 run generally parallel to each other. The end panels 86 and 88 run generally parallel to each other. Each of the end panels 86, 88 runs generally at a right angle to each of the side panels 82, 84. Floor 90 runs generally at a right angle to each of the panels 82, 84, 86 and 88. The panels 82, 84, 86, 88 and floor 90 form a receptacle 92 having an upper opening 94 formed by upper edges 96 of the panels 82, 84, 86 and 88. Receptacle 92 runs from the upper opening 94 to the floor 90.

Side panels 82 and 84 oppose each other. End panels 86 and 88 oppose each other. Receptacle 92 is between the side panels 82 and 84 and is further between the end panels 86 and 88. Each of the panels 82, 84, 86 and 88 has a lower portion confronting and engaging the floor 90.

Each of the panels 82, 84, 86 and 88 includes an outer layer 98 and an inner layer 100. Each of the panels 82, 84, 86 and 88 further includes, sandwiched between each of the outer and inner layers 98, 100, a semi-rigid, somewhat flexible, resilient plastic plate or piece 102 such that body 78 includes a set of four pieces 102. Each of the pieces 102 is rectangular and runs from the floor 90 to the upper edge 96. Floor 90 preferably does not include such a plastic piece 102 such that floor 90 wraps at least partially around the cylindrical stem 36. Each of the end pieces 102 that are engaged in the end panels 86 and 88 includes a relatively straight lower edge. The straight lower edge in distal end panel 88 may confront the upper surface 66 of the stem 36 and run perpendicular across stem upper surface 66 or may confront and run along and on top of the upper surface of the handlebar section 60 in the axial direction of the handlebar section 60. The straight lower edge of the end proximal piece 102 engaged in the proximal end panel 86 can confront the upper edge 68 of the stem 36 or may confront an upper surface of the post like upper portion 32 of the fork 28. The straight lower edges of the side pieces 102 engaged in the side panels 82 and 84 confront the stem 36 in an axial direction of the stem 36 at a height slightly lower than the extreme upper surface of the stem 36. If desired, the lower edges of the end pieces 102 can take another shape, such as a rounded shape tailored to the cylindrical shape of the stem 36 or such as a shape that is customized to the stem ends 62 and 64 or such as a shape that is customized to the handlebar and fork connections at the stem ends 62 and 64.

The outer and inner layers 98 and 100 of panels 82, 84, 86 and 88 are formed of a flexible sheet material or fabric. Such flexible sheet material is preferably nylon. Floor 90 is preferably formed of a flexible sheet material or fabric. Such flexible sheet material is preferably nylon.

Each of the side panels 82 and 84 is stitched along upright (or height wise) edge portions to upright (or height wise) edge portions of the end panels 86 and 88. Each of the side panels 82 and 84 is stitched along longitudinally extending lower edge portions to longitudinally extending edge portions of the floor panel 90. Each of the end panels 86 and 88 is stitched along laterally extending lower edge portions to laterally extending lower edge portions of the floor panel 90.

The outer layer 98 of proximal end panel 86 and floor 90 is formed of one-piece of flexible sheet material or fabric.

A front face of front side panel 82 includes a strip 104 of quick connect and release material. Strip 104 runs generally to and between end panels 86 and 88 and confronts the upper edge 96 of the front side panel 82. Strip 104 is rectangular in shape. Strip 104 includes a relatively great height. If desired, strip 104 can extend from such upper edge 96 to the floor 90 or to a lower portion of panel 82 confronting the floor 90. Preferably, such strip 104 extends between about one-third to about one-half of the distance from such upper edge 96 to the floor 90.

Lid 79 includes a strip 106 of quick connect and release material for engaging strip 104. Strip 106 is about the same length as strip 104. The width (or height) of strip 106 is somewhat less than the width (or height) of strip 104. The relative tightness of the lid 79 relative to the upper edges 96 can be adjusted by the height at which strip 106 engages strip 104. The quick connect and release material is preferably a hook and loop type of quick connect and release material such as Velcro®.

Lid 79 is formed of a flexible material. Preferably, such flexible material includes a webbed material 108. Lid 79 is engaged, such as by stitching, to the back panel 84 and extends from between the outer and inner layers 98, 100 of the back panel 84. Lid 79, when closed as shown in FIG. 2B, at least partially closes off receptacle 92.

Connectors 80 include a first pair of quick connect and release straps 110, a second pair of quick connect and release straps 112, and a third pair of quick connect and release straps 114.

Straps 110 are side straps. One of the straps 110 extends from the junction of front side panel 82 and floor 90 and the other of the straps 110 extends from the junction of rear side panel 84 and floor 90 such that each of the straps 110 includes a proximal end portion 116 that confronts a lower portion of one of the side panels 82, 84. Each of the side straps 110 includes a face 118 having a quick connect and release material such as a hook and loop type of material. The faces 118 engage each other such that straps 110 may be tightened about stem 36 at the proximal end portion 64 of the stem 36.

Straps 112 are corner straps that confront a corner of container 76 formed by front side panel 82 and distal end panel 88. Straps 112 include a side strap 112-S and an end strap 112-E. Side strap 112-S extends from the junction of front side panel 82 and floor 90 and end strap 112-E extends from the junction of distal end panel 88 and floor 90 such that strap 112-S includes a proximal end portion 116 that confronts a lower portion of side panel 82 and such that strap 112-E includes a proximal end portion 116 that confronts a lower portion of distal end panel 88. Each of the straps 112 includes a face 118 having the hook and loop type of material such that straps 112 may engage each other and such that straps 112 may be tightened about handlebar section 60.

Straps 114 are corner straps that confront a corner of the container 76 that is formed by back side panel 84 and distal end panel 88. Straps 114 include a side strap 114-S and an end strap 114-E. Side strap 114-S extends from the junction of rear side panel 84 and floor 90 and end strap 114-E extends from the junction of distal end panel 88 and floor 90 such that strap 114-S includes a proximal end portion 116 that confronts a lower portion of side panel 84 and such that strap 114-E includes a proximal end portion 116 that confronts a lower portion of distal end panel 88. Each of the straps 114 includes a face 118 having the hook and loop type of material such that straps 114 may engage each other and such that straps 114 may be tightened about handlebar section 60.

Straps 110, 112, and 114 are formed of a flexible material such as nylon. Preferably, the entire face 118 (or one entire side) of each of the straps 110, 112, and 114 has thereon one of a hook type of material or one of a loop type of material such that connectors are provided along the entire length of one side of each of the straps 110, 112, and 114. In other words, hook type material or loop type material runs on one face (or side) of the strap from the proximal end 116 to a distal end 120 of each of the straps 110, 112, and 114. If the inner face of one strap includes connectors, then preferably the outer face of the cooperating strap includes connectors.

Each of the straps 110, 112, and 114 is engaged to the body 78 and is engagable to its cooperating strap. Straps 110 oppose each other. The proximal end portions 116 of corner straps 112 confront each other and are disposed at generally a right angle relative to each other. The proximal end portions 116 of corner straps 114 confront each other and are disposed at generally a right angle relative to each other. The proximal end portion 116 of strap 112-E confronts the proximal end portion 116 of strap 114-E and these proximal end portions lie generally coplanar with each other and may slightly overlap each other.

Straps 110 can be one-piece from distal end portion 120 of one strap 110 to the distal end portion 120 of the other strap 110. Strap 112-S can be one-piece with strap 114-S from one distal end portion 120 to the other distal end portion 120.

In operation, to connect the container 76 to the bicycle 10, the floor 90 of the container 76 may be placed on the upper surface 66 of the stem 36. Then straps 110 may be engaged relatively tightly about the stem 36 or the proximal end portion 64 of the stem 36. Then one of the strap pairs 112, 114 may be engaged to handlebar section 60 and tightened to handlebar section 60. Then the other of the strap pairs 112, 114 may be engaged to handlebar section 60 and tightened to handlebar section 60. Or, if desired, straps 112, 114 may be engaged first, with straps 110 being engaged last. When fixed to stem 36, floor 90 of the container 76 rides on the stem 36 and may further ride on portions of the handlebar section 60 and portions of the post like upper portion 32 of fork 28.

In operation, when in use, container 76 rides on stem 36 without spinning over to one side and without leaning over to one end. Straps 112 minimize travel of the container 76 along the length of the handlebar 34 (along the axis of the handlebar section 60) in one direction since stem 36 impedes travel of the straps 112. Straps 114 minimize travel of the container 76 along the length of the handlebar 34 in the other direction since stem 36 impedes travel of the straps 114. Straps 110 also minimize travel of the container 76 along the length of the handlebar section 60. Straps 112 and 114 minimize a spinning of the container 76 about an axis of stem 36. Straps 112 and 114 also minimize travel of the container 76 along the length of the stem 36 (along the axis of the stem 36). Straps 112 and 114 minimize upward lifting of the distal end of container 76 that may be caused by wind. Straps 110 minimize upward lifting of the proximal end of the container 76 that may be caused by an inadvertent bump by the rider. Movement such as a spinning or a leaning or a lifting or some other movement of the container 76 may also occur when a rider in competition is opening lid 79 with one hand and keeping the other hand on handlebar 34 or 38 and straps 110, 112, and 114 work to minimize movement of the container 76 relative to the stem 36.

In operation, when in use, container 76 may carry watches, keys, and food such as high energy food that triathletes carry in competition. Lid 79 can be quickly and easily operated to take out and put back the contents of the receptacle 92 while the rider is riding the bicycle 10.

In operation, to remove the container 76 from the stem 36, the straps 110, 112, and 114 are disengaged. Container 76, since semi-rigid pieces 102 are independent from each other and since floor 90 includes no panel, may be stored in a relatively flat form.

In operation, if desired, the aerobars 38 including the connectors 70, may be adjusted so as to pinch the container 76 therebetween or so as to lend side support to the side panels 82 and 84.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalents of the claims are intended to be embraced therein.

I claim:

1. A bicycle engaging container, comprising:
a) a body comprising a pair of side panels opposing each other, a pair of end panels opposing each other, a floor, and a receptacle, with the receptacle being between the side panels and end panels, with each of the side panels having a lower portion, and with each of the end panels having a lower portion;
b) a pair of first quick connect and release straps engaged to the body and engagable to each other, with one of the first quick connect and release straps having a proximal end portion confronting the lower portion of one of the side panels, with the other of the first quick connect and release straps having a proximal end portion confronting the lower portion of the other of the side panels, with the proximal end portions of the first quick connect and release straps opposing each other;
c) a pair of second quick connect and release straps engaged to the body and engagable to each other, with one of the second quick connect and release straps having a proximal end portion confronting the lower portion of one of the side panels, with the other of the second quick connect and release straps having a proximal end portion confronting the lower portion of one of the end panels; and
d) a pair of third quick connect and release straps engaged to the body and engagable to each other, with one of the third quick connect and release straps having a proximal end portion confronting the lower portion of one of the side panels, with the other of the third quick connect and release straps having a proximal end portion confronting the lower portion of one of the end panels;
e) whereby side-oriented straps engage end-oriented straps.

2. The bicycle engaging container of claim 1, wherein the proximal end portions of the second quick connect and release straps are disposed at generally a right angle to each other.

3. The bicycle engaging container of claim 1, wherein the proximal end portions of the third quick connect and release straps are disposed at generally a right angle to each other.

4. The bicycle engaging container of claim 1, wherein the proximal end portions of the second and third quick connect and release straps that confront the end panel also confront each other.

5. The bicycle engaging container of claim 1, wherein the proximal end portions of the second and third quick connect and release straps that confront the end panel lie generally coplanar with each other.

6. The bicycle engaging container of claim 1, and further comprising a pair of corners, with one of the corners being between one of the side panels and one of the end panels, with the other of the corners being between the other of the side panels and said one end panel, with the second pair of quick connect and release straps confronting one of the corners, and with the third pair of quick connect and release straps confronting the other of the corners.

7. The bicycle engaging container of claim 1, and further comprising a quick connect and release lid engaged to and between at least two of the panels for at least partially covering the receptacle.

8. The bicycle engaging container of claim 1, and further comprising the bicycle, with the bicycle comprising a handlebar and a fork, and with the bicycle further comprising a stem between the handlebar and the fork, with the bicycle engaging container engaging the stem of the bicycle, and with the floor of the container riding on the stem of the bicycle.

9. The bicycle engaging container of claim 8, wherein the container further engages the handlebar of the bicycle.

10. The bicycle engaging container of claim 1, wherein the container is mounted on a stem of the bicycle, with said stem being engaged between a handlebar and fork of the bicycle.

11. The bicycle engaging container of claim 10, wherein the container further engages the handlebar of the bicycle.

12. A bicycle and container combination comprising:
a) the bicycle, with said bicycle comprising a handlebar for turning the bicycle, a fork for engaging a front wheel of the bicycle, and a stem engaged between the handlebar and the fork; and
b) the container, with the container engaging the stem of the bicycle, and with the container comprising a floor riding on the stem.

13. The bicycle and container combination of claim 12 wherein the container further engages the handlebar of the bicycle.

14. The bicycle and container combination of claim 12, wherein the container comprises a pair of quick connect and release straps engaging the stem of the bicycle.

15. The bicycle and container combination of claim 12, wherein the container comprises a pair of quick connect and release straps for engaging the handlebar of the bicycle.

16. The bicycle and container combination of claim 15, wherein the container comprises an additional pair of quick connect and release straps for engaging the handlebar of the bicycle.

17. The bicycle and container combination of claim 12, wherein the container comprises:
a) a pair of first quick connect and release straps engaging the stem of the bicycle;
b) a pair of second quick connect and release straps for engaging the handlebar of the bicycle; and
c) a pair of third quick connect and release straps for engaging the handlebar of the bicycle.

18. A bicycle stem mounted container, with said stem being engaged between a handlebar and fork of said bicycle, with the container comprising a lower portion comprising a floor, with the container strapped to said stem such that said floor rides on said stem.
